(19) United States
(12) Patent Application Publication
(10) Pub. No.: US 2008/0256147 A1
(43) Pub. Date: Oct. 16, 2008

(54) Method and a System for Storing Files

(75) Inventors: Pankaj Anand, Haryana (IN); Nitin Arora, Haryana (IN); Puneet Trehan, Haryana (IN); Rakesh Sharrma, Haryana (IN); Aniruddha Chaudhuri, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Medical Research Council, London (GB)

(21) Appl. No.: 12/090,488

(22) PCT Filed: Oct. 18, 2006
(86) PCT No.: PCT/IB06/02910

§ 371 Date: Apr. 17, 2008

(30) Foreign Application Priority Data
Oct. 18, 2005 (IN) 2783/DEL/2005

(51) Int. Cl. G06F 17/30

(52) U.S. Cl. 707/205; 707/3; 707/E17.001

(57) ABSTRACT

The present invention presents a method and a system of indexing, storing and retrieving data to and from multiple, remote and connected data sources over internet or intranet. Files are shredded into fixed number of strips using a defined pattern (shredding algorithm) and distributed randomly amongst the storage data sources (storage nodes). A unique index is maintained for each file and its strips along with corresponding storage nodes in a central file-storage database. On demand to retrieve a file, file-storage database is looked up for all relevant strips and storage nodes containing them. These file strips are then collected from all storage nodes and dressed back according to a defined anti-pattern (dressing algorithm) to the pattern used for shredding them. Failover control for storage nodes can be achieved by replicating each strip for a fixed number of storage nodes (replication factor). In case a storage node is not available, the next storage node containing the same strip can be used to get the strip back.

### FIELD OF THE INVENTION

The present invention generally relates to a method and a system for storing files in a secure manner on file storage servers.

### BACKGROUND AND PRIOR ART DESCRIPTION

There is an increasing demand of storing files in a secure and robust manner on the files storage servers. The security generally refers to encryption of the files before storing them on the file servers.

Moreover, the files being stored have to be distributed on multiple locations or servers. They can be physically or logically separated from one another like separate file servers or different drives on the same hard drive respectively. This also poses a requirement for balancing the load on each file server and even distribution of data on them.

### OBJECTS OF THE PRESENT INVENTION

It is an object of the present invention, at least in the preferred embodiments, to overcome or ameliorate at least one of the disadvantages of the prior art, or to provide a useful alternative method of storing files in a secure manner on file storage servers. It is another object of the present invention, at least in the preferred embodiments, to overcome or ameliorate at least one of the disadvantages of the prior art, or to provide a useful alternative system for storing files in a secure manner on file storage servers.

### BRIEF DESCRIPTION OF THE INVENTION

According to a first aspect of the present invention there is provided a method for storing a file on one or more servers or storage-locations in a secure manner.

In accordance with an embodiment of the present invention, the method of storing the file comprises the steps of stripping the file to be stored into predetermined number of pieces, called strips, and distributing the strips thus obtained on one or more servers or storage-locations.

In accordance with another embodiment of the present invention, the strips thus obtained are indexed prior to distribution. During the process of indexing the strips, information relating to the strips thus being stored is stored in an index. Without limiting and purely by way of example, information about the strip's identity, storage location of the strip is stored in the index to ensure uniform loading. More particularly, file identifier information, strip identifier information, servers or storage-locations identifier information, shredding information, relative path of the strip in the server or the storage-location and any other relevant data which may be useful in retrieving the strips is stored in the index.

In accordance with yet another embodiment of the present invention, the strips thus obtained are distributed randomly and particularly absolutely randomly on the one or more servers or storage locations so as to ensure uniform loading or filling of the one or more servers or storage-locations.

In accordance with still another embodiment of the present invention, at least two copies of at least one strip thus obtained in stored in one or more servers or storage-locations.

The method described in the first aspect of the present invention including its various embodiments makes the file storage method more secure and evenly distributed among one or more servers or storage locations.

According to a second aspect of the present invention there is provided a method which enables retrieving a file stored on one or more servers or storage locations on demand by a user.

In accordance with an embodiment of the present invention, the method of retrieving the file comprises retrieving strips that constitute the file from the one or more servers or storage locations where they are stored and dressing or assembling the strips thus retrieved to form the file.

In accordance with another embodiment of the present invention, the method further comprises the step of querying an index for information relating location at which the strip is stored.

In accordance with still another embodiment of the present invention, if a strip stored at a particular server or storage location is non-retrievable, the method further comprises the step of further querying the index for information relating location(s) at which additional copy of the strip, if any, is stored.

In accordance with one more embodiment of the present invention, if a strip stored at a particular server or storage location is non-retrievable, the method further comprises the step of further querying the index for information relating locations at which additional copies of the strip, if any, are stored.

In accordance with one another embodiment of the present invention, if the index is further queried, the method of retrieving the file comprises retrieving copy of the strip from the one or more servers or storage locations where they are stored and dressing or assembling the strips thus retrieved to form the file.

In accordance with a further embodiment of the present invention, the method comprises the step of returning back the file thus dressed or assembled to the user.

According to a third aspect of the present invention there is provided a system for storing a file on one or more servers or storage-locations in a secure manner.

In accordance with an embodiment of the present invention, the system for storing a file comprises: a receiver for receiving the file to be stored from a user, a stripper means operationally coupled to the receiver for receiving the file to be stored and stripping the same into a predetermined number of pieces, called strips, and a distributing means operationally coupled between one or more servers or storage-locations and the stripper means for distributing the strips thus obtained on the one or more servers or storage-locations.

In accordance with another embodiment of the present invention, the strips thus obtained are indexed by an indexing means and provided to the distribution means.

The indexing means is configured to store information relating to the strips thus being stored in the index. Without limiting and purely by way of example, the indexing means is configured to store file identifier information, strip identifier information, servers or storage-locations identifier information, shredding information, relative path of the strip in the server or the storage-location and any other relevant data which may be useful in retrieving the strips.

In accordance with yet another embodiment of the present invention, the system is further provided with a replication factor generator for generation a replication factor so as to enable storing at least two copies of at least one strip in one or more servers or storage-locations.

According to a second aspect of the present invention there is provided a system which enables retrieving a file stored on one or more servers or storage locations on demand by a user.

In accordance with an embodiment of the present invention, the system for retrieving a file stored on one or more servers or storage locations on demand by a user comprises: a receiver means for receiving the demand from the user, a retrieving means operationally coupled to the one or more servers or storage locations where strips are stored for retrieving the strips, a dresser means or assembling means operationally coupled between the retrieving means and a transmitter for dressing or assembling the strips so as to form or constitute the original file and the transmitter transmitting the original file to the user.

In accordance with another embodiment of the present invention, the retrieving means and/or the dresser means is coupled to the indexing means for retrieving the strips from the respective one or more servers or storage locations where they are stored and dressing or assembling the strips so as to form or constitute the original file.

### BRIEF DESCRIPTION OF THE ACCOMPANYING DRAWINGS

In the drawings accompanying the specification,

FIG. 1 shows the schematic diagram of the method for storing files in accordance with a first aspect of the present application.

FIG. 2 shows the data flow diagram for stripping.

FIG. 3 shows a schematic representation of a file stripped into a two-dimensional array of strips (also referred to as chunks).

FIG. 4 shows the process of vertical reading of a file stripped into a two-dimensional array of strips (as shown in FIG. 4) to constitute vertical stripping.

FIG. 5 shows the process of traversal of the two-dimensional array of strips and distribution of the strips on one or more servers or storage locations.

FIG. 6 shows the data flow diagram for dressing.

FIG. 7 shows the process of retrieval of the strips from the one or more servers or storage locations and their gathering for dressing.

FIG. 8 shows the process of vertically combining the strips collected (shown in FIG. 7) to form a two-dimensional array of strips thereby constituting vertical dressing, which is a reversal of the vertical stripping (shown in FIG. 4).

FIG. 9 shows the system for storing files in accordance with the second aspect of the present application.

### DETAILED DESCRIPTION OF THE EMBODIMENTS

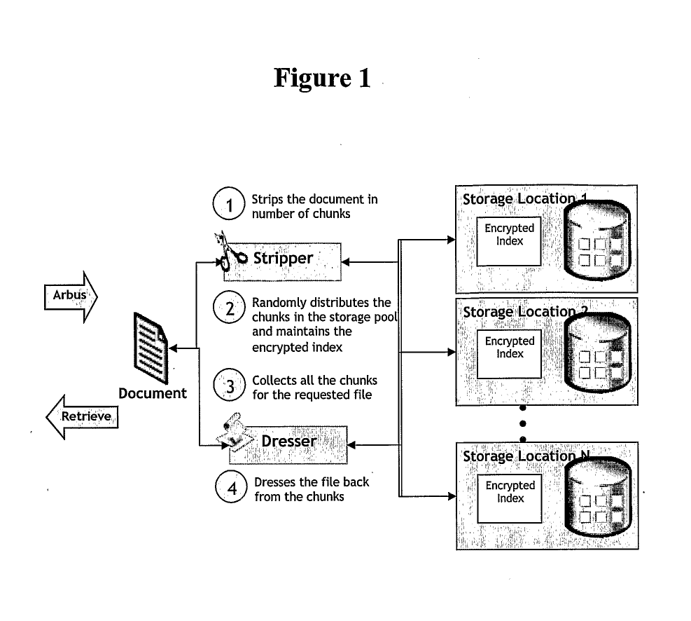

The schematic diagram of the entire process for storing files in accordance with a first aspect of the present application which comprises the steps of stripping and dressing is shown in FIG. 1. In the following paragraphs, the Applicants would describe in details the stripping process and the dressing process using a few examples. The following paragraphs are provided purely by way of illustration and the scope of the invention should not be construed to be limited in any manner by the following paragraphs.

Stripping Process:

The process of dividing a file into number of pieces is called stripping and the divided pieces are called strips. The process of stripping may use more than one algorithm to strip a file. These various stripping algorithms present a new pattern of stripping a file. The pattern can be horizontal, vertical, diagonal, or absolutely random.

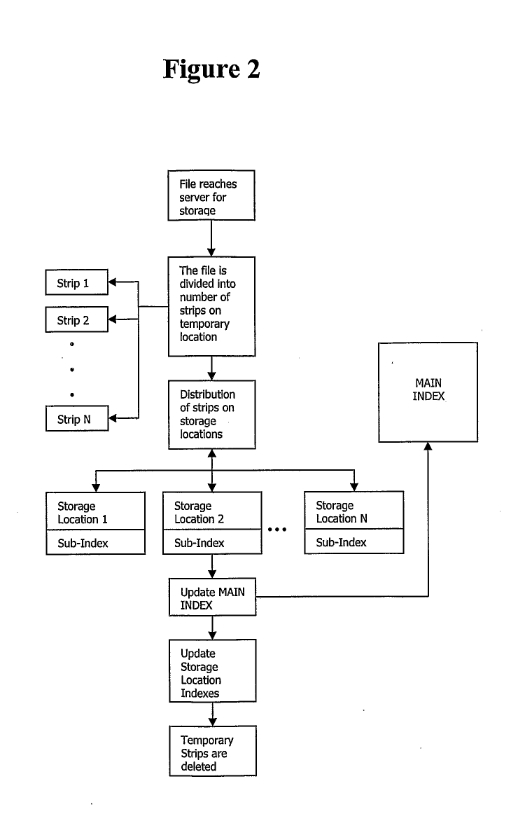

As shown in FIG. 2, on the request of file storage, the file is divided in number of strips in a temporary location. An algorithm followed determines various parameters like the number of strips the file is going to be divided into, the pattern of slicing the file (e.g. slicing the file horizontally or slicing the file vertically or slicing the file diagonally or slicing the file randomly or a combination thereof). The choice of algorithm is based on the level of security required.

These strips are then stored randomly on various storage locations. The distribution is absolutely random and maintains the same average load on each storage location.

These entries for file strips are stored in the available Storage Location in the form of sub-index.

This sub-index helps the method of the present application to find a strip from any storage location. It contains the file sub-index, file path and time-related fields. These storage locations can be on the same machine or on different machines on the network. This sub-index is stored in encrypted form for security reasons. Detailed description of the indexes is provided separately in the following pages under the heading “Indexes”.

A main index of the files is also maintained through which a file is linked to the storage locations containing its strips. This main index also stores the information used for stripping the file. The strips are then deleted from the temporary location after being distributed randomly. For the purpose of increasing the security, at least one strip thus obtained in replicated to different storage locations. For the purpose of doing so, a replication factor is generated. By way of example, if the replication factor generated is two, then two copies of the same strip are maintained at two different locations. This enhances the availability of the strip and the security against loss of a strip. Stripping is explained below by using vertical stripping.

Vertical Stripping:

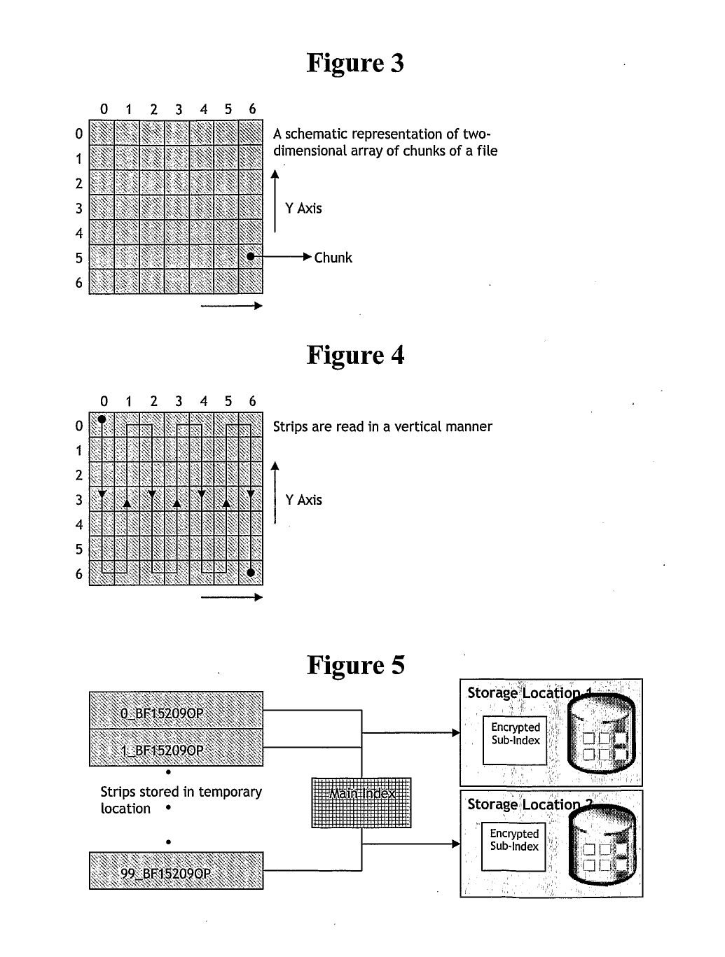

The file to be stripped is sequentially stored in an array into the memory. The memory array is subsequently stripped into two-dimensional array of strips (also referred to as chunks). FIG. 3 shows a schematic representation of a file being stored in a memory location and being stripped into a two-dimensional array of strips.

Assuming, that the stripping is based on the size of the strip, the file of 100 KB can be divided in the 100 strips of size 1 KB. (KB refers to Kilo Bytes). In this case the size of two-dimensional symmetric array becomes 10×10. The maximum size of the X-axis dimension of the array is fixed as 10. The array is then read vertically starting from the 0×0 strip vertically down as shown in the FIG. 4. The process of reading the array vertically starting from the 0×0 strip vertically down as shown in the FIG. 4 is referred to as vertical stripping in the present application.

Each strip read is stored in a temporary location for distribution. The strips are stored by naming them sequentially like 01_FileID, 02_FileID and son on. These are the strip IDs which are given sequential names in order to know the sequence of dressing. After having traversed all the strips and storing them in temporary location, these strips are then read in a sequential manner and distributed randomly on different storage location. After storing a strip in a storage location, an entry is made in the sub-index of that storage location. This entry in the sub-index links the file strip with the exact path in the storage location. Another entry in made into the main-index with the application which links the file with the storage location its strips are distributed to.

The format of the main index and sub-index is described after this example. FIG. 5 explains the entire process of traversal of the array and distribution of strips.

Dressing Process:

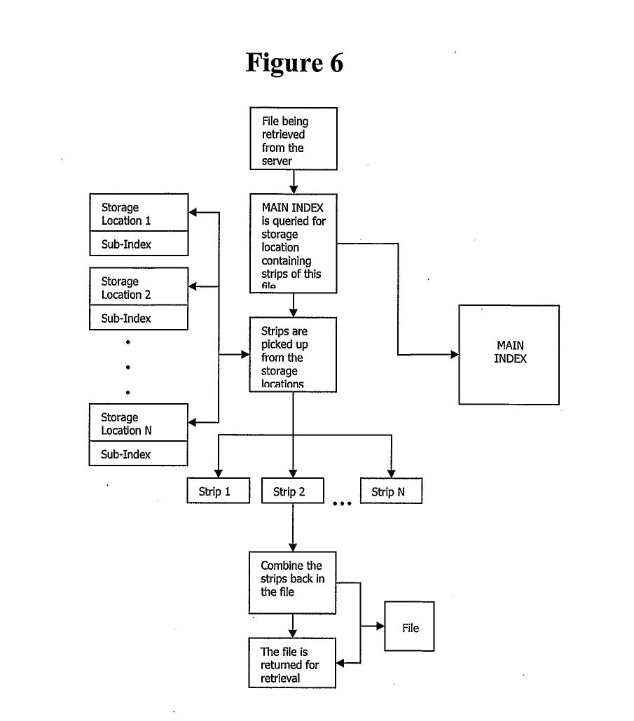

As shown in FIG. 6, on the request of retrieval for a file, the main index is queried for the storage locations the application should look up to for strips of this file. The sub-index for each storage location is used to get the complete paths of the strips. The strips are then read from these locations in a temporary location and dressed back.

The dressing algorithm is determined from the stripping algorithm from the main index. The strips once dressed in a file are deleted from the temporary location. This complete file is then returned back for retrieval. This process of joining strips to make a complete file is known as dressing. In other words, the process of combining a number of pieces into a complete original file is called dressing.

The process of dressing uses the same stripping algorithm applied in reverse from which the file was stripped. The information about the stripping algorithm is found from the main index. The pattern to dress the strips back in the complete file can be horizontal, vertical, diagonal, or absolutely random depending upon the stripping algorithm used. Vertical Dressing corresponding to the vertical stripping explained above will be described hereafter.

Vertical Dressing:

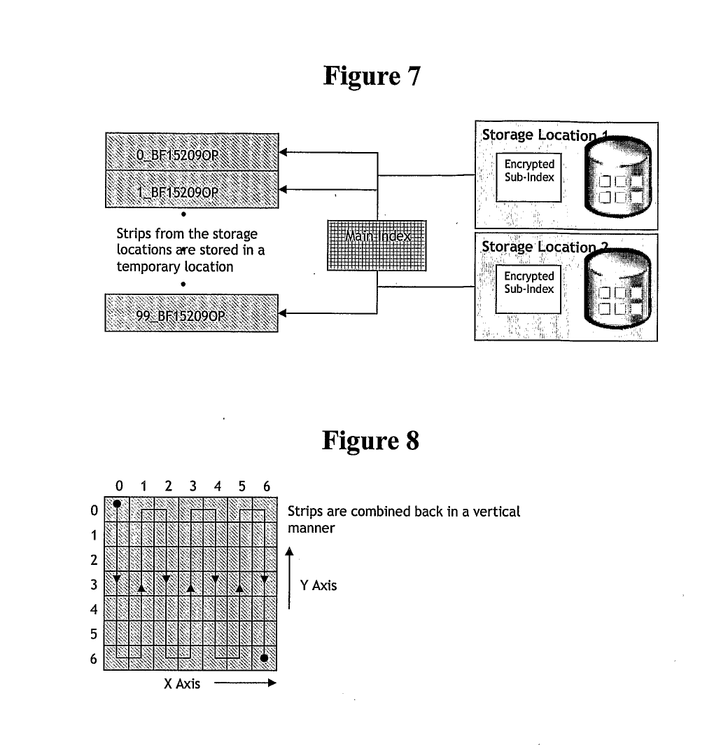

Information about the file to be dressed is found from the main index. The main-index is looked up for the stripping algorithm used, strip IDs and the storage location where these strips can be found. For each strip, the corresponding storage location is looked up through its sub-index to get the complete path of the strip. These strips are now read from these storage locations and are gathered together in a temporary location for dressing. Schematic of the process of retrieval of the strips from the one or more servers/storage locations and their gathering for dressing is shown in FIG. 7.

Once the strips are gathered, the strips are named according to their IDs which determine the sequence in which the strips are to be dressed back. These strips are picked up sequentially and are combined using a vertical dressing algorithm which is the vertical stripping algorithm applied in reverse. This is explained in FIG. 8.

The strips when combined back in to a two dimensional array is then stored as a file. This file is then checked for its integrity which marks the successful completion of dressing process.

Indexes

As described in the previous paragraphs, the information about the files, strips, storage location, and algorithm used is stored in two indexes, Main-Index and Sub-Index. The main-index lies with the application responsible for providing stripping and dressing mechanism. This application is the one which is responsible for storage and retrieval of files. The sub-index is stored in the storage location. These indexes are stored in an encrypted format. The encryption used is blowfish encryption, but various other encryption techniques like 3DES, RSA can also be used instead. These indexes can also be stored on disc as a file or in a database. The basic structures for these indexes are given below. This represents an abstract view of the index, and is subjected to expand or changed for better performance.

The main index should have provision for storing at least the following data:
(a) File ID
(b) Strip & Storage Location ID and
(c) Algorithm ID

In addition to the above-mentioned fields, the main index can contain other additional fields which are desired by the user as per his requirement. Usually, the main index is in tabular form and looks as shown below:
1. Main-Index

| | | |
|---|---|---|
| File ID | Strip & Storage Location ID | Algorithm ID |

The sub index should have provision for storing at least the following data:
(a) Strip ID
(b) Relative path from storage location root

In addition to the above-mentioned fields, the sub index can contain other additional fields which are desired by the user as per his requirement. Usually, the sub index is in tabular form and looks as shown below:
2. Sub-Index

| | |
|---|---|
| Strip ID | Relative path from storage location root |

Handling Corruption or Loss of Indexes

It was noticed that the entire purpose of the invention would have been defeated if the index storing the information are lost due to handling corruption or any other reason.

Hence, to overcome this defect, the method and the system of the present invention takes a backup of the indexes, i.e. a second safe copy of these indexes is maintained in a safe location to recover from this loss. Moreover, the strips are named such that indexes can be recreated in this situation.

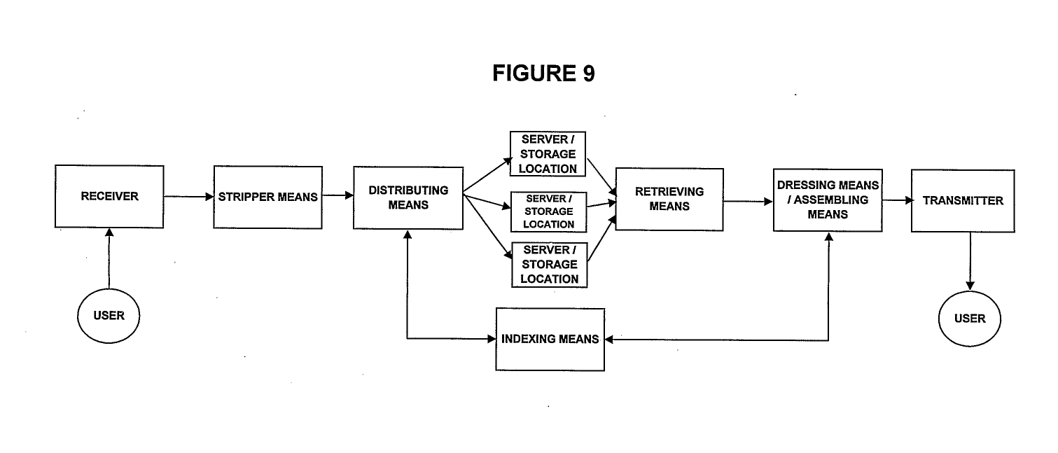

As can be seen from FIG. 9, the system for storing the files comprising: a receiver for receiving a file to be stored from a user, a stripper means operationally coupled to the receiver for receiving the file to be stored and stripping the same into a number of pieces, called strips, and a distributing means operationally coupled between on one or more servers or storage-locations and the stripper means for distributing the strips thus obtained on the one or more servers or storage-locations. The strips thus obtained are indexed by an indexing means and are distributed so as to ensure uniform loading (filling) of the one or more servers or storage-locations, particularly, the strips thus obtained are distributed randomly and more particularly, absolutely randomly on the one or more servers or storage locations and their indexes, their storage location and any other relevant data are stored in an indexing means to ensure uniform loading and retrieval.

It can be noticed that the system is further provided with a retrieving means operationally coupled to the one or more servers or storage locations where strips are stored for retrieving the strips, a dresser means or assembling means operationally coupled between the retrieving means and a transmitter for dressing or assembling the strips so as to form or constitute the original file and the transmitter transmitting the original file to the user.

The retrieving means and/or the dresser means is coupled to the indexing means for retrieving the strips from the respective one or more servers or storage locations where they are stored and dressing or assembling the strips so as to form or constitute the original file.

Advantages of Stripping & Dressing Mechanism:
1. Secure Storage: The storage of files becomes more secure through stripping and dressing. The files once stripped and distributed can in no way be re-compiled back in the original file without the sub-index and algorithm used during stripping. The sub-index is strongly encrypted and the algorithm is an integral part of the application which is hack proof. Hence, the storage of files is more secure that storing files directly on the storage.
2. Even distribution of load: Mostly, there is more than one storage location to store files on the server. These locations can be different hard drives on the same machines or storage on different machines. Stripping and dressing mechanism store files on these randomly thereby balancing the load and amount of files on these locations.

We claim:

1. A method of storing a file on one or more servers or storage-locations in a secure manner, said method comprises the steps of:
stripping the file to be stored into predetermined number of pieces, called strips, and
distributing the strips thus obtained on one or more servers or storage-locations.

2. The method as claimed in claim 1, wherein the strips thus obtained are indexed prior to distribution and wherein information relating to the strips thus being stored is stored in an index during the step of indexing.

3. The method as claimed in claim 2, wherein information about the strip's identity, storage location of the strip is stored in the index to ensure uniform loading.

4. The method as claimed in claim 2, wherein file identifier information, strip identifier information, servers or storage-locations identifier information, shredding information, relative path of the strip in the server or the storage-location and any other relevant data which may be useful in retrieving the strips is stored in the index.

5. The method as claimed in claim 2, wherein the index is in the form of a main index and a sub-index.

6. The method as claimed in claim 1, wherein the strips thus obtained are distributed randomly and particularly absolutely randomly on the one or more servers or storage locations so as to ensure uniform loading or filling of the one or more servers or storage-locations.

7. The method as claimed in claim 1, wherein at least two copies of at least one strip thus obtained in stored in one or more servers or storage-locations.

8. A method of retrieving a file stored on one or more servers or storage locations on demand by a user, said method comprises the steps of:
retrieving strips that constitute the file from the one or more servers or storage locations where they are stored; and
dressing or assembling the strips thus retrieved to form the file.

9. The method as claimed in claim 8, wherein the method further comprises the step of querying an index for information relating location at which the strip is stored.

10. The method as claimed in claim 8, wherein if a strip stored at a particular server or storage location is non-retrievable, the method further comprises the step of further querying the index for information relating location(s) at which additional copy of the strip, if any, is stored.

11. The method as claimed in claim 8, wherein if a strip stored at a particular server or storage location is non-retrievable, the method further comprises the step of further querying the index for information relating locations at which additional copies of the strip, if any, are stored.

12. The method as claimed in claim 10, wherein if the index is further queried, the method of retrieving the file comprises retrieving copy of the strip from the one or more servers or storage locations where they are stored and dressing or assembling the strips thus retrieved to form the file.

13. The method as claimed in claim 8, wherein the method comprises the step of returning back the file thus dressed or assembled to the user.

14. A system for storing a file on one or more servers or storage-locations in a secure manner, the system comprising: a receiver for receiving the file to be stored from a user, a stripper means operationally coupled to the receiver for receiving the file to be stored and stripping the same into a predetermined number of pieces, called strips, and a distributing means operationally coupled between one or more servers or storage-locations and the stripper means for distributing the strips thus obtained on the one or more servers or storage-locations.

15. The system as claimed in claim 14, wherein the strips thus obtained are indexed by an indexing means and provided to the distribution means and wherein the indexing means is configured to store information relating to the strips thus being stored in the index.

16. The system as claimed in claim 14, wherein the system is further provided with a replication factor generator for generation a replication factor so as to enable storing at least two copies of at least one strip in one or more servers or storage-locations.

17. A system for retrieving a file stored on one or more servers or storage locations on demand by a user, the system comprising: a receiver means for receiving the demand from the user, a retrieving means operationally coupled to the one or more servers or storage locations where strips are stored for retrieving the strips, a dresser means or assembling means operationally coupled between the retrieving means and a transmitter for dressing or assembling the strips so as to form or constitute the original file and the transmitter transmitting the original file to the user.

18. The system as claimed in claim 17, wherein the retrieving means and/or the dresser means is coupled to the indexing means for retrieving the strips from the respective one or more servers or storage locations where they are stored and dressing or assembling the strips so as to form or constitute the original file.
